(19) United States
(12) Patent Application Publication
(10) Pub. No.: US 2021/0068356 A1
(43) Pub. Date: Mar. 11, 2021

(54) Wood Fibre Mat for Use as a Plant Substrate

(71) Applicant: SWISS KRONO Tec AG, Luzern (CH)

(72) Inventors: Norbert Kalwa, Horn-Bad Meinberg (DE); Jens Siems, Malchin (DE)

(21) Appl. No.: 16/772,283

(22) PCT Filed: Dec. 3, 2018
(86) PCT No.: PCT/EP2018/083312

§ 371 Date: Jun. 12, 2020

(30) Foreign Application Priority Data
Dec. 18, 2017 (EP) 17208071.5
Mar. 12, 2018 (EP) 18161207.8

(51) Int. Cl. A01G 24/23; A01G 24/44

(52) U.S. Cl. CPC A01G 24/23; A01G 24/44

(57) ABSTRACT

The present disclosure is directed to a wood fibre mat for use as a plant substrate including wood fibres, and at least one polar liquid absorbing agent, and a biodegradable binder consisting of polylactic acid fibres and at least one starch. The disclosure also relates to processes for its production.

The present invention relates to a wood fibre mat for use as a plant substrate, its use and methods for its manufacture.

### Description

In agriculture and horticulture, especially in greenhouses, more and more products are being used to improve, facilitate and cheapen the growing of plants. An important aspect in this context is the exact adjustment of the nutrient content for the plants.

One approach in this context is the use of suitable substrate components that have good drainage properties in combination with low nutrient content, high structural stability and good airflow. The desired values for nutrient content and pH-value can be precisely adjusted by liming and fertilization.

Peat is often used as the traditionally preferred substrate component. Peat can be distributed easily and quickly and is an ideal substrate starting material with adjustable water capacity. Peat, especially white peat, has good airflow even when water is saturated, while black peat has a higher cation exchange capacity and better pH buffering. Peat is traditionally extracted from raised bogs and fens, which is increasingly ecologically unacceptable. Due to the high demand for peat, it is increasingly being imported, which leads to high costs and also causes ecological damage in some areas of the extraction country.

Besides peat, a large number of other possible substrate components are known. For example, the use of xylitol (precursor of lignite), mineral substrates such as vermiculite, porous volcanic rock, oil shale or rock wool is increasingly being discussed.

In the case of rock wool, the glass fibres, which are hydrophobic in themselves, were made hydrophobic with the aid of surfactants and other auxiliary substances (DE 4024727 A1). The mineral wool can also be provided with water absorbing agents such as fumed silica, clay minerals, aluminium oxide or an organic superabsorber such as an acrylamide/acrylic acid copolymer to improve the water retention capacity (DE 4035249 A1).

Especially when using rock wool or mineral wool as plant substrate, there are a number of disadvantages. For example, the production of rock wool is energy-intensive, and ecological disposal is either impossible or difficult, e.g. the addition of reduced rock wool to earthy substrates is ecologically controversial. Although it is possible to recycle stone wool by adding it, for example, in brick production, the overall conclusion is that the recycling of stone wool is not sufficiently solved. In addition, plant mats made of rock wool are treated with chemical substances to generate the desired properties of the end product. Long transport routes are also required after the life cycle phase of the mats to the respective disposal or recycling processing companies, which further contributes to the negative ecological balance.

Therefore, many of these substrates have the problem of disposal, which has a negative effect on the products in terms of both effort and cost. As an example, substrates based on glass or rock wool are only mentioned here. These are used today, especially in the Netherlands. The annual requirements for such substrates are more than 300,000 m³ per year with a thickness of 80 mm, which corresponds to an area of more than 3.5 million m².

Accordingly, there is still a very large demand for soilless substrates. Here, since the 1990s, the use of wood fibres has established itself as a further alternative for substrate components. Initially, wood fibres were used as peat substitute in potting soils, but in the meantime they have gained importance as organic substrate components in horticulture. Wood fibres are often used in mixtures with reduced or no peat content. Of all peat substitutes, wood fibres are most similar to peat in their properties, with the exception of water capacity. Thanks to their pore structures, wood fibres have a significantly higher air capacity than peat and are basically weed-free. The loose structure of the wood fibres provides good drainage properties and makes the substrates resistant to potting or structurally stable. A major disadvantage of the wood fibres, however, is that the high air capacity is at the expense of a comparatively low water capacity.

Possible alternatives based on wood fibre mats have the disadvantage, however, that they often lead to a low pH value when watered in the water because of the wood fibres, which hinders the optimal absorption of minerals by the plant. For most vegetable plants, the pH value of the soil/substrate should be around or above 4.5. This is especially true for tomatoes or cucumbers, which are mainly cultivated in greenhouses on substrates. In addition, the wood fibre mats release wood ingredients (acetic acid, formic acid), which are responsible for the low pH value and can also lead to an odour nuisance through the emission of these wood ingredients. This is especially true since the room loading of greenhouses with such substrates is relatively high and, in addition, increased emissions occur due to the high temperatures in the greenhouses.

The present invention is therefore based on the technical object of providing the wood fibres, known per se as soilless substrate, so that the defects described above do not occur. In doing so, no precursor products should be used which are problematic in terms of disposal. Furthermore, the product should be environmentally friendly with regard to its entire ecological profile (production from renewable raw materials, low energy consumption during production, easy disposal due to biodegradability, etc.).) should be classified as positive. In addition, the product should be comparable in use with products currently on the market in terms of properties.

According to the invention, this object is solved by a wood fibre mat with the features of claim 1 and its production in a process according to claim 11.

Accordingly, a wood fiber mat is provided for use as a plant substrate comprising wood fibers, and at least one polar liquid absorbing agent, said wood fiber mat further comprising 5-10% by weight (based on the amount of wood fibers) of a biodegradable polylactic acid fiber binder and 5-10% by weight (based on the amount of wood fibers) of at least one starch.

Thus, a wood fibre mat is made available which comprises a combination of two binders, namely a combination of polylactic acid fibres as a synthetic binder and starch as a natural binder.

Surprisingly, the use of the specific combination of polylactic acid fibres and starch as a binder leads to an increase in the pH value in the wood fibre mat compared to a wood fibre mat made with PET fibres. This is noticeable despite small additions of the starch binder in relation to wood fibres. A reduction in odour is also noticeable with regard to the acetic acid content. Thus, the starch binder seems to reduce the emission of acetic acid, since the degradation reactions are probably reduced by the increased pH value.

The wood fibre mat according to the invention thus has various advantages. A specific pH adjustment of the plant mat is possible. The acetic acid emission is reduced. The wood fibre mat according to the invention can be easily disposed of, e.g. by composting the substrate mats after the life cycle phase. The substrate mats are fully recyclable. The higher absorption behaviour of the substrate mats ensures that the substrate moisture can be adjusted precisely and evenly during the vegetation phase of the plants. This results in a faster and more consistent growth behaviour of the plants. The thus more precise dosage results in a finer distribution of the added nutrients in the fibre composite. Nutrients can be supplied more precisely to the root system. Furthermore, the wood fibre mat according to the invention has a significantly reduced tendency to mould growth.

In an embodiment of the present wood fibre mat, the starch used as a binder is selected from the group comprising potato starch, maize starch, wheat starch, rice starch.

Starch is a polysaccharide with the formula (C₆H₁₀O₅)ₙ, which consists of α-D-glucose units The macromolecule is therefore a carbohydrate. Under the influence of heat, starch can physically bind, swell and stick together many times its own weight in water. When heated with water, the starch swells at 47-57° C., the layers burst, and at 55-87° C. (potato starch at 62.5° C., wheat starch at 67.5° C.) starch paste is formed, which has different stiffening properties depending on the type of starch (corn starch paste larger than wheat starch paste, the latter larger than potato starch paste) and decomposes more or less easily under acidification.

Starch can be used both in its native form and in modified (derivatised) form as a binder. Thus at least one starch can be present in the wood fibre mat in native or modified (derivatised) form. DuraBinders from Ecosynthetix is the preferred starch-containing binder.

If modified or derivatized starch is used as a binder, it can be selected from a group comprising cationic or anionic starch, carboxylated starch, carboxymethylated starch, sulfated starch, phosphorylated starch, etherified starch such as hydroxyalkylated starch (e.g. hydroxyethylated starch, hydroxypropylated starch), oxidized starch containing carboxyl or dialdehyde groups and hydrophobic starches such as acetate, succinate, semi- or phosphate esters.

It is also generally conceivable to use a mixture of a natural starch and a derivatised starch or of several natural starches and/or several derivatised starches.

In the present wood fibre mat the at least one starch is contained in an amount between 5 to 10% by weight, preferably 5 to 8% by weight, especially preferably 5 to 7% by weight, based on the amount of wood fibres (atro). The greater the amount of added starch, the lower the strength of the produced wood fibre mat for processing and transport. It is advantageous if the amount of starch is not more than 10% by weight, but preferably less than 10% by weight. A mat bonded with more than 10% by weight of starch will not result in a manageable product, as the strength is not given.

The polylactic acid fibres are contained in the present wood fibre mat in an amount of between 5 and 10% by weight, preferably 5 to 8% by weight, in particular preferably 5 to 7% by weight, based on the amount of wood fibres (atro). It is generally also conceivable to use more than 10% by weight of polylactic acid fibres, e.g. 15% by weight or 20% by weight. However, this would lead to an increase in the strength of the wood fibre mat to an extent that would impair plant growth.

In a particularly preferred design, polylactic acid fibres with a length of 38 mm +/−3 mm and a fineness of 1.7 dtex are used.

As mentioned above, the present wood fibre mat has an increased pH value compared to wood fibre mats with non-biodegradable binders or binding fibres. Thus the wood fibre mat in question can have a pH value of more than 4.0, preferably more than 4.4. The pH-value range of the wood fibre mat at hand is between 4.0 and 8.0, preferably between 4.4 and 7.0, especially preferably between 4.8 and 6.0.

The pH value of the wood fibre mat present is at least 1.0 higher than in a wood fibre mat produced with non-biodegradable binders/binding fibres (e.g. polyethylene fibres, biko fibres). The pH value of the wood fibre mat is determined by placing a mixture of wood fibres, starch and polylactic acid fibres in water and then determining the pH value of the aqueous solution.

As also mentioned above, the wood fibre mat according to the invention has a reduced odour, especially of acetic acid.

In one version of the present wood fibre mat, the at least one absorbent is distributed evenly (homogeneous) or unevenly (inhomogeneous) in the wood fibre mat.

In case of a homogeneous distribution of the absorbent in the wood fibre mat, the at least one absorbent is preferably evenly distributed over the entire thickness or width of the wood fibre mat. Accordingly, the absorbent in this case has a uniform concentration in the mat.

Preferably, the amount of absorbent in the final wood fibre mat is between 1-10% by weight, preferably 1.5-5% by weight, especially preferably 1.5% by weight, based on the total weight of wood fibres, with a uniform distribution.

In the case of a first variant of uneven distribution of the absorbent in the wood fibre mat, the at least one absorbent may be distributed or arranged in at least one predetermined position of the wood fibre mat. Accordingly, the distribution of the absorbent takes place within a layer of the wood fibre mat, from which the absorbent can diffuse into the adjacent areas within the wood fibre mat.

In this variant of distributing the absorbent in one layer or ply in the wood fibre mat, the amount of absorbent can be between 10 and 100 g/m², preferably 30 to 80 g/m², especially preferably 50 to 60 g/m². The advantage of arranging the absorbent in one layer within the wood fibre mat is in particular that the amount of absorbent can be controlled as a function of plant size and water requirements during the production of the wood fibre mat, in a simple manner via the amount of absorbent scattered.

In a further, second variant of the uneven distribution of the absorbent in the wood fibre mat, the at least one absorbent can be provided locally limited in the wood fibre mat. A locally limited arrangement of the absorbent in the wood fibre mat is, for example, in a recess (e.g. hole, notch, etc.) made in the wood fibre mat.

In a particularly preferred embodiment of the present wood fibre mat, an acrylic-based polymer, in particular a copolymer of acrylic acid and acrylate, is used as the at least one absorbent. Such acrylic-based absorbents with particle sizes between 100-1000 μm are also known as superabsorbents, which are able to absorb many times their own weight of polar liquids such as water. When the liquid is absorbed, the superabsorber swells and forms a hydrogel.

In the present case, the absorbent in a particularly preferred version consists of a copolymer of potassium polyacrylate and polyamide.

In general, the use of other absorbents such as clay minerals, in particular layer silicates, silica gel or aluminium oxide is also possible.

To generally improve the wettability of the wood fibre mat, surfactants can also be added to the fibres, e.g. in the blowline. It is also possible to spray surfactants in front of the oven.

It is still preferred if the wood fibre mat in question contains at least one antimicrobial agent. The antimicrobial agent used here is particularly effective against bacteria, yeasts, fungi or algae. Hinokitol or also polyamines can be used as fungicides.

The antimicrobial agent used preferentially penetrates the cell wall of the microorganisms and acts as a selective allosteric inhibitor of various enzymes, in particular of enzymes of cell wall biosynthesis or ribosomal protein biosynthesis.

Another alternative is the use of antimicrobially active peptides (AMP) or lysozyme.

The antimicrobial agent can be used in an amount between 0.5-5% by weight, preferably 1-4% by weight, especially preferably 2% by weight, based on the amount of wood fibres in the wood fibre mat.

The antimicrobial agent is preferably applied to the top of the fibre cake of wood fibres and binder before compacting and calibrating. However, it is also possible and conceivable to bring the at least one antimicrobial agent directly into contact with the mixture of wood fibres, biodegradable binder and absorbent prior to application to the conveyor belt, i.e. prior to the formation as a pre-fleece, e.g. by addition in the blow-line.

In another preferred embodiment, the present wood fibre mat contains plant nutrients which ensure a sufficient supply of nitrogen, phosphates, sulphur and other trace elements to the plants. An additional supply of plant nutrients to the wood fibre mat is necessary, as wood fibres themselves have a low nutrient content. However, the wood fibre mats offer the advantage that a targeted adjustment of the nutrient content is possible through lime and fertilisation.

The plant nutrients are preferably added during or after the production of the wood fibre mat.

The addition of the plant nutrients to the wood fibres can be carried out in the Blow-Line or sprayed onto the pre-fleece. Another possibility is that the nutrients are added to the plant mat with the water.

In the case of nitrogen as a nutrient, it could be applied as urea in the blowline. This would also improve the wettability of the plant mat during use.

The wood fibres used in the present wood fibre mat are dry wood fibres with a length of 1.0 mm to 20 mm, preferably 1.5 mm to 10 mm and a thickness of 0.05 mm to 1 mm. The wood fibre moisture content of the fibres used is in a range between 5 and 15%, preferably 6 and 12%, in particular preferably 10%, based on the total weight of the wood fibres

The present wood fibre mat has a thickness of between 20 and 200 mm, preferably 50 and 150 mm, especially preferably 80 and 100 mm.

The gross density of the present wood fibre mat is 50-250 kg/m³, preferably 70-170 kg/m³, especially preferably 100-140 kg/m³.

As explained above, the present wood fibre mat can be used as a plant substrate or substrate component in agriculture or horticulture. In particular, the use of the wood fibre mat for roof greening or also for plant breeding is conceivable.

The present wood fibre mat can be produced in a process with the following steps:
(a) production of wood fibres from lignocellulosic raw material
(b) Contacting the wood fibres with at least part of a solution of at least one starch,
(c) drying of the wood fibres mixed with the at least one starch,
(d) contacting the wood fibres mixed with the at least one starch with polylactic acid fibres
(e) applying the mixture of wood fibres, starch and polylactic acid fibres to a conveyor belt to form a fibre cake; and
f) Heating and compressing the fibre cake into a wood fibre mat.

To produce the wood fibres according to step a), the wood chips are first cleaned, then defibrated and dried.

Contacting the wood fibres with at least part of a starch solution in step (b) is preferably done by a blow-line process, in which the starch solution is injected into the wood fibre stream, resulting in a homogeneous distribution of the starch on the wood fibres. It is possible that the starch solution for wood fibre cross-linking is added to a wood fibre/steam mixture in the blow line.

However, it is also conceivable to bring the starch solution into contact with the wood fibres by means of dry gluing. The starch solution is applied to the dried wood fibres by extremely fine atomisation. Such dry gluing drastically reduces the consumption of starch solution compared to blow-line gluing.

In accordance with the procedure described above, the wood fibres containing the starch solution are then dried (see step c). The drying can be done in a raw dryer (e.g. known from the wood-based panel industry).

In a variant of the production process described above, the wood fibres mixed with at least one starch are passed over a blowing line together with the polylactic acid fibres and blown onto a conveyor belt. In the blow pipe, the components (step d) are intensively mixed by the air blown in as a means of transport. The quantity of fibre mixture supplied depends on the desired layer thickness and the desired density of the wood fibre mat to be produced.

If consolidation of the surface of the wood fibre mat is desired, this can be achieved by spraying the fibre cake surfaces with starch solution before consolidation.

The step of compacting is carried out at temperatures between 120° C. and 220° C., preferably 150° C. and 200° C., especially 170° C. and 180° C., whereby the fibre cake is compacted to a thickness between 20 and 200 mm, preferably 50 and 150 mm, especially preferably 80 and 100 mm. This can be done in a circulating air oven, in which hot air flows through the mat. The mat is formed from the fleece in the oven when hot air flows through it, whereby adhesive points are formed between the wood fibres and the biodegradable polylactic acid fibres by heating them. Although the other component is also an adhesive, the polylactic acid fibres form a supporting matrix for the mat—especially as the mat becomes thicker.

Alternatively, a hot press could be used instead of the oven and the flow of hot air, in which the heat is mainly introduced into the web through contact with the hot press plates to form mats. For this reason the fleece is often preheated before the hot press.

In the finishing stage, the fibre mat is finally reduced to the desired dimensions and cooled; cooling is preferably carried out during calibration and in the cooling zone of the continuous furnace.

In one process variant, at least one (further) part of the solution of the at least one starch together with the polylactic acid fibres is contacted (mixed) with the wood fibres in step d). This can be done by spraying the fibre mixture in the mixing station.

In a further process variant, in a step e1) the mixture of wood fibres, starch and polylactic acid fibres is applied to a first conveyor belt to form a pre-fleece and in a step e2) the pre-fleece is defibred and mixed and the fibre mixture is applied to a second conveyor belt to form a fibre cake.

In a further embodiment, the at least one absorbent is applied to the pre-fleece and/or the fibre cake. This can be done, for example, by using a powder scatterer.

If the absorbent is scattered onto the pre-fleece, the pre-fleece mixed with the absorbent is defibered at the end of the first conveyor belt, which is blown onto a second conveyor belt after mixing again.

It is also conceivable to scatter the absorbent onto the pre-fleece, onto which a further quantity (or layer) of a mixture of wood fibres and the binder combination is then applied.

According to this process variant, a first layer of a fibre mixture of wood fibres and binder combination (e.g. in an amount between 1000 and 2000 g/m², preferably 1500 g/m²) is blown or scattered onto the conveyor belt, then the absorbent is applied as a second layer to this fibre mixture or also pre-fleece and then a further, third layer of a fibre mixture of wood fibres and binder combination (e.g. in an amount between 2000 and 3000 g/m², preferably 2500 g/m²) is applied to the pre-fleece. Correspondingly, in this case the absorbent is incorporated as a two-dimensional layer or layer within the wood fibre mat, resulting in an inhomogeneous distribution of the absorbent in the wood fibre mat. Due to this specific layered arrangement of the absorbent, the concentration of the absorbent is locally increased within the wood fibre mat.

In an even further version, the at least one antimicrobial agent is applied (e.g. sprayed on) to the pre-fleece (e.g. before defibration at the end of the first conveyor belt) and/or the fibre cake. The fibre cake is preferably provided on the upper side with the at least one antimicrobial agent and then transferred to an oven in which the final calibration and/or compaction takes place.

In yet another of the existing wood fibre mats, the absorbent is locally limited. For this purpose, at least one recess is made in the finished wood fibre mat into which the at least one absorbent is introduced. This can be done together with a plant seed or a young plant.

In this variant, the absorbent is therefore only introduced into the mat at a predetermined location after pressing or compacting. The advantage of this variant is that the wood fibre mat does not absorb any unnecessary moisture during storage and thus prior to its actual use as a substrate component, thus avoiding possible mould or rotting processes of the wood fibre mat due to an increased moisture content.

The amount of absorbent introduced per well or hole can be between 1 and 50 g, preferably between 1 and 20 g, and especially preferably between 1 and 10 g. Again, the amount depends on the plant size, the size of the well and the water requirements.

The invention is explained in more detail below with reference to several examples.

### Example 1

In a refiner, wood fibres are produced from wood chips, which are then mixed with a starch binder (Ecosynthetix) in the blowline. The added quantity was 5% by weight solid on wood atro. Different types of wood can be used, preferably softwood. The glue had a solids content of approx. 50%. This mixture was then dried to a moisture content of about 10%.

These wood fibres with starch binder are then mixed in a fibre mixer with polylactic acid fibres, (called PLA fibre) (proportion of polylactic acid fibres: approx. 5 wt % on wood fibres atro). The PLA fibres have a length of 38 mm +/−3 mm and a fineness of 1.7 dtex.

An endless mat is produced from the mixture by blowing it onto a conveyor belt. Afterwards, the mat is mixed again and placed on another conveyor belt. Approx. 5600 g mixture/m² are spread.

The fibre cake is then heated in a convection oven to temperatures of 120 -180° C. and calibrated to the desired thickness and thus compressed. During calibration, the fibre cake is cooled with cooling air to approx. 30-40° C. The production speed of the conveyor belt was 5 m/min. At the end of the circulating air oven the mat is compacted to 80 mm.

As a reference, a wood fibre mat with binding fibres based on PET (polyethylene terephthalate) of the same thickness and density (approx. 70 kg/m³) was produced. The proportion of binding fibres was approx. 7% by weight. The continuous fibre mat is used to produce cut-to-size or rolled products.

### Example 2

In a refiner, wood fibres are produced from wood chips, which are then mixed with a starch binder (Ecosynthetix) in the blowline. The added quantity was 10% weight % solid on wood atro. The glue had a solids content of approx. 50%. This mixture was then dried to a moisture content of about 10%.

These wood fibres with starch binder are then mixed with polylactic acid fibres in a fibre mixer (proportion of polylactic acid fibres: approx. 3 wt % on wood fibres atro). The PLA fibres have a length of 22 mm +/−3 mm and a fineness of 1.7 dtex.

A mat is produced from the mixture by blowing it onto a conveyor belt. Afterwards, the mat is mixed again and placed on a conveyor belt. Approx. 5600 g mixture/m² are spread.

The fibre cake is then heated in a circulating air oven to temperatures of 120-180° C. and compressed. The speed of the conveyor belt was 5 m/min. At the end of the oven the mat is compacted to 80 mm. The endless fibre mat is used to produce cut-to-size or rolled products.

In addition to the pH value, the odour was also analysed on the samples. This was carried out by a group of people experienced in the olfactometric evaluation of products.

| | Zero sample | Sample 1 | Sample 2 |
|---|---|---|---|
| pH value* | 3.4 | 4.4 | 4.8 |
| Odour Insulation material | clearly acidic, | Non-specific | Non-specific |
| after production | vinegar-like | | |

*Amount of 1 g fibres were put into 50 ml distilled water, after approx. 10 minutes the pH value was determined

As can be seen from the table, insulating materials produced with starch and polylactic acid fibres have a significantly higher pH value, which is beneficial to plant growth.

### Design example 3

In a refiner, wood fibres are produced from wood chips, which are then mixed with a starch binder (Ecosynthetix) in the blowline. The added quantity was 5% by weight solid on wood atro. Different types of wood can be used, preferably softwood. The glue had a solids content of approx. 50%. This mixture was then dried to a moisture content of about 10%.

These wood fibres with starch binder are then mixed in a fibre mixer with polylactic acid fibres, (called PLA fibre) (proportion of polylactic acid fibres: approx. 5 wt % on wood fibres atro). The PLA fibres have a length of 38 mm +/−3 mm and a fineness of 1.7 dtex.

An endless mat is produced from the mixture by blowing it onto a conveyor belt. Afterwards, the mat is mixed again and placed on another conveyor belt. Approx. 5600 g mixture/m² are spread.

The fibre cake is then heated in a convection oven to temperatures of 120-180° C. and calibrated to the desired thickness and thus compressed. During calibration, the fibre cake is cooled with cooling air to approx. 30-40° C. The production speed of the conveyor belt was 5 m/min. At the end of the circulating air oven the mat is compacted to 80 mm.

As a reference, a wood fibre mat with binding fibres based on polylactic acid fibres of the same thickness and density (approx. 70 kg/m³) was produced. The proportion of binding fibres was approx. 7% by weight. The continuous fibre mat is used to produce cut-to-size or rolled products. A sample was taken from the mat and stored in a desiccator above water. For comparison, the reference sample, which had only been prepared with polylactic acid, was also tested. It turned out that the reference sample or zero sample showed a clearly visible mould growth after about two months, whereas the test mat did not show this growth. In addition, a clearly earthy smell was noticeable when opening the desiccator. At best, this smell could be guessed when opening the desiccator with the test mat.

1. A wood fiber mat for use as a plant substrate comprising wood fibers, and at least one polar liquid absorbing agent, further comprising:
5-10% by weight, based on the quantity of wood fibres, of a biodegradable binder of polylactic acid fibres and 5-10% by weight, based on the quantity of wood fibres, of at least one starch.

2. The wood fiber mat according to claim 1, wherein the at least one starch is selected from the group consisting of: potato starch, corn starch, wheat starch, and rice starch.

3. The wood fibre mat according to claim 1, wherein the at least one starch is present in native or modified form.

4. The wood fiber mat according to claim 1, wherein the at least one starch is a derivatized starch selected from the group consisting of: cationic or anionic starch, carboxylated starch, carboxymethylated starch, sulfated starch, phosphorylated starch, etherified starch, oxidized starch containing carboxyl or dialdehyde groups and hydrophobic starches.

5. The wood fibre mat according to claim 1, wherein the at least one starch is contained in an amount between 5 to 8% by weight, based on the amount of wood fibres (atro).

6. The wood fibre mat according to claim 1, wherein the polylactic acid fibres are contained in an amount between 5 to 8% by weight, based on the amount of wood fibres (atro).

7. The wood fibre mat according to claim 1, comprising a pH of more than 4.0

8. The wood fibre mat according to claim 1, wherein the at least one absorbent is an acrylic-based polymer.

9. The wood fibre mat according to claim 1, comprising at least one antimicrobial agent in an amount of between 0.5-5 wt %, based on the amount of wood fibres.

10. A plant substrate comprising the wood fibre mat according to claim 1.

11. A process for producing a wood fiber mat according to claim 1, comprising:
(a) production of wood fibres from lignocellulosic raw material,
(b) contacting the wood fibres with at least part of a solution of at least one starch,
(c) drying of the wood fibres mixed with the at least one starch,
(d) contacting the wood fibres mixed with the at least one starch with polylactic acid fibres,
(e) applying the mixture of wood fibres, starch and polylactic acid fibres to a conveyor belt to form a fibre cake, and
f) heating and compressing the fibre cake into a wood fibre mat.

12. The process according to claim 11, wherein at least a part of the solution of at least one starch together with the polylactic acid fibres is contacted with the wood fibres in step d).

13. The process according to claim 1, wherein in a step e1) the mixture of wood fibres, starch and polylactic acid fibres is applied to a first conveyor belt to form a pre-fleece and in a step e2) the pre-fleece is defibered and mixed and the fibre mixture is applied to a second conveyor belt to form a fibre cake.

14. The process according to claim 13, wherein at least one absorbent is applied to the pre-fleece and/or the fibre cake.

15. The process according to claim 13, wherein at least one antimicrobial agent is applied to the pre-fleece and/or the fibre cake.

16. The wood fibre mat according to claim 5, wherein the at least one starch is contained in an amount between 5 to 7% by weight, based on the amount of wood fibres (atro).

17. The wood fibre mat according to claim 6, wherein the polylactic acid fibres are contained in an amount between 5 to 7% by weight, based on the amount of wood fibres (atro).

18. The wood fibre mat according to claim 7, comprising a pH of more than 4.4.

19. The wood fibre mat according to claim 8, wherein the acrylic-based polymer comprises a co-polymer of acrylic acid and acrylate.
